(19) United States
(12) Patent Application Publication
(10) Pub. No.: US 2022/0385483 A1
(43) Pub. Date: Dec. 1, 2022

(54) CREDENTIAL BOOTSTRAPPING

(71) Applicant: Kigen (UK) Limited, Cambridgeshire (GB)

(72) Inventors: Hannes TSCHOFENIG, Tirol (AT); Paul David BRADLEY, Allauch (FR)

(21) Appl. No.: 17/383,876

(22) Filed: Jul. 23, 2021

Related U.S. Application Data
(60) Provisional application No. 63/193,714, filed on May 27, 2021.

(51) Int. Cl. H04L 9/32; H04L 9/08; H04L 29/06; H04L 29/08

(52) U.S. Cl. CPC H04L 9/3268; H04L 9/3265; H04L 9/0877; H04L 63/166; H04L 63/164; H04L 63/04; H04L 67/141; H04L 67/10

(57) ABSTRACT

A device can establish operational credentials for enabling the device to provide an attestation of the device's identity to another party, by performing a method comprising: obtaining bootstrap credentials from a hardware secure element or a trusted execution environment (TEE) of the device; using the bootstrap credentials to establish a secure session with an enrolment server; and via the secure session, establishing the operational credentials with the enrolment server.

### BACKGROUND

### Technical Field

The present technique relates to establishment of operational credentials for a device.

### Technical Background

Electronic devices, such as an Internet of Things (IoT) device, may need to communicate with server associated with another party, e.g. a cloud server associated with a cloud service. To enter into communication with the server, the server may require the device to provide an attestation of the device's identity, so that the server can decide whether to trust the device and continue communicating with the device. Hence, it may be desired to provide the device with operational credentials which enable a device to make attestations to the device's identity.

### SUMMARY

At least some examples provide a method for a device to establish operational credentials for enabling the device to provide an attestation of the device's identity to another party; the method comprising: obtaining bootstrap credentials from a hardware secure element or a trusted execution environment (TEE) of the device; using the bootstrap credentials to establish a secure session with an enrolment server; and via the secure session, establishing the operational credentials with the enrolment server.

At least some examples provide a non-transitory storage medium storing a computer program to control a device to perform the method described above.

At least some examples provide a device comprising: processing circuitry; and at least one of: a hardware secure element; and a trusted execution environment (TEE) implemented on the processing circuitry; in which: the processing circuitry is configured to: obtain bootstrap credentials from the hardware secure element or the TEE; use the bootstrap credentials to establish a secure session with an enrolment server; and via the secure session, establish operational credentials with the enrolment server, the operational credentials for enabling the device to provide an attestation of the device's identity to another party.

Further aspects, features and advantages of the present technique will be apparent from the following description of examples, which is to be read in conjunction with the accompanying drawings.

### BRIEF DESCRIPTION OF THE DRAWINGS

FIG. 1 illustrates server-generated credentials;

FIG. 2 illustrates client-generated credentials;

FIG. 3 illustrates Enrollment over Secure Transport (EST) according to RFC 7030;

FIG. 4 illustrates software executed on an IoT (Internet of Things) device;

FIG. 5 illustrates an example of use of IoT SAFE in an example where the TLS stack is run on the MCU;

FIG. 6 illustrates another example of use of IoT SAFE in an example where the TLS stack is implemented in the modem within the cellular module;

FIG. 7 illustrates merging of IoT SAFE with EST for credential bootstrapping;

FIG. 8 is a ladder diagram illustrating a communication flow for credential bootstrapping;

FIG. 9 shows an example where a TEE holds the bootstrap credentials and generates and protects the private key used for the operational credentials;

FIG. 10 is a flow diagram showing a method performed by a device to obtain operational credentials and use the operational credentials to enter into communication with a cloud server; and

FIG. 11 is a flow diagram showing a method performed by a device to establish the operational credentials with an enrolment server.

### DESCRIPTION OF EXAMPLES

One approach to providing a device with operational credentials that it can use to attest to its identity when accessing a server can be to embed the operational credentials in the device at a manufacturing stage. However, a disadvantage with this approach is that this may require the relationships between the device and the cloud services with which the device may communicate to be set in advance at the time of manufacturing the device, which may offer limited flexibility for using the device with services that are unknown at the time of manufacture. For example, a sensor device may be manufactured and sold and then may be usable across a range of cloud services so that the service with which the sensor device will be used may not be known at the time of manufacture.

In the technique discussed in this application, a device can use credential bootstrapping to establish the operational credentials. A method comprises obtaining bootstrap credentials from a hardware secure element (HSE) or a trusted execution environment (TEE) of the device, using the bootstrap credentials to establish a secure session with an enrolment server, and via the secure session, establishing the operational credentials with the enrolment server.

With this approach, the operational credentials which eventually are used to attest to the device's identity when accessing a remote server can be established when the device is operational in the field, rather than at manufacture, so that the relationship between the device and the cloud service does not need to be predetermined at the time of manufacture. The bootstrap credentials provided within the device can be used to establish a secure communication session with an enrolment server and the operational credentials can be established via the secure session. Using a HSE or TEE of the device to provide the bootstrap credentials improves security because the HSE or TEE provide security measures to restrict access to the bootstrap credentials.

In some cases, the enrolment server could be the same server as the operational server that will ultimately engage with the device using the operational credentials. However, the enrolment server could also be a separate server from the operational server. For example, the enrolment server could be a server operated by a third party service which can manage enrolment of IoT devices to cloud services, and part of the enrolment process can include the establishment of the operational credentials via the secure communication session with the device.

The method performed at the device may comprise generating, in the HSE or the TEE, an operational key pair comprising an operational private key and an operational public key. The operational credentials established with the enrolment server may comprise an operational public key certificate that is associated with the operational public key. Hence, subsequent to the credential bootstrapping method being performed, the device can use the operational public key certificate when accessing a remote cloud service so that the cloud service operator can verify, from the operational public key certificate, information about the devices identity. The operational private key generated within the HSE or TEE can be used by the device to generate a signature included in communications sent to the server, and the server can then use the operational public key associated with the operational public key certificate to verify the signature to establish whether the device the server is communicating with is the device that has possession of the operational private key.

When the device establishes the operational credentials through the secure session established with the enrolment server, the device may send a certificate signing request (CSR) specifying the operational public key to the enrolment server, and subsequently receive the operational public key certificate from the enrolment server. For example, the enrolment server may either itself act as a certification authority (CA) capable of generating public key certificates, or could forward the CSR to a certification server associated with another party acting as the CA and receive the operational public key certificate from the certification server and return it to the device.

During the enrolment process, the operational private key generated in the HSE or the TEE or the device may remain exclusively within the HSE or the TEE. Since the private key never leaves the hardware secure element or TEE, this greatly improves security compared to approaches where the operational private key is generated in a part of the device outside the HSE or TEE or where the operational private key is generated at a server and communicated to the device. Retaining the operational private key in the HSE or TEE reduces risk of leakage of the operational private key.

The generation of the operational key pair associated with the operational credentials may be performed within the hardware secure element or TEE, in response to a request by software of the device that is executed outside the HSE or TEE, according to IoT SAFE (IoT SIM Applet for Secure End-2-End Communication). IoT SAFE is a standard defined by GSMA which enables a hardware secure element to function as a root of trust in an IoT device, to improve security when establishing communications between an IoT device and a cloud server. Hence, by using the protocols defined in IoT SAFE to manage communication between software of the device executed outside the HSE/TEE and an applet executing within the HSE/TEE and to manage key generation within the HSE/TEE, this can improve security. Although IoT SAFE specifies use of a hardware secure element, it would be possible for an IoT SAFE applet to execute within an TEE of a device using the same communication protocols and key generation protocols that are defined in IoT SAFE for the hardware secure element, so that an IoT SAFE applet running within the TEE can also be used to provide secure generation of the operational key pair.

The establishment of the operational credentials may be performed according to Enrollment Over Secure Transport (EST). EST is a standard developed by the internet engineering task force (IETF) which can be used by devices to obtain public key certificates vis a secure communication session. However, EST does not mandate any particular requirement for protecting the bootstrapping keys used to establish the secure session with the enrolment server or the operational keys generated when establishing the operational credentials. By using a HSE or TEE or provide the bootstrap credentials and to generate the operational key pair and retain the operational private key, this greatly improves security for a device enrolling with a remote service using EST.

Hence, the combination of IoT SAFE for protecting the keys using a HSE or TEE with EST for performing the establishment of operational credentials via secure transport has several advantages. Compared to use of IoT SAFE alone, the establishment of the operational credentials via a secure session avoids the need for an over the air (OTA) update platform to provide the operational credentials which would typically require coordination between each cloud provider and each mobile network operator, and also makes IoT SAFE accessible to non-cellular devices since the provisioning solution for the operational credentials is connectivity-agnostic. Compared to use of EST alone, security is bolstered by leveraging the HSE or TEE which provides on-board key generation so that the key pair generated for the operational credentials remains within the HSE or TEE.

The bootstrap credentials may comprise a bootstrap public key certificate and a bootstrap private key, where the bootstrap public key certificate is sent to the enrolment server to establish a secure session and the bootstrap private key remains exclusively within the HSE or the TEE of the device. The bootstrap public key and bootstrap public key certificate may be obtained from the HSE, and the bootstrap key pair and the bootstrap public key certificate may be pre-installed in the hardware secure element of the device at the manufacturing stage. Manufacturers may have secure key injection processes for controlling the generation of the bootstrap credential keys at manufacturing in a controlled manner avoiding key leakage (e.g. the key injection may be such that the manufacturer does not gain knowledge of the private key generated within the device), and so this may be relatively secure. Subsequently, as the bootstrap private key remains exclusively within the HSE or the TEE then this maintains security as it is not possible for other devices to learn the bootstrap private key so that the enrolment server can be confident that in communicating with the device that the device which provides evidence of possession of the bootstrap private key is the correct device.

A request for the bootstrap public key certificate to be provided by the hardware secure element or the TEE, to software of the device executing outside the hardware secure element or the TEE, may be made according to the protocols identified in IoT SAFE.

The secure session used to communicate with the enrolment server for the purpose of establishing the operational credentials may be a secure session via an internet protocol (IP) communication channel.

The secure session may be via any protocol which provides protection against interception. However, in one example a secure session may be secured by transport layer security (TLS) or datagram transport layer security (DTLS). TLS and DTLS provide cryptographic protocols to provide communication security when communicating with a remote device over an IP communication channel. The keys and public key certificate associated with the bootstrap credentials may be used in the TLS or DTLS protocol to perform a handshake with the enrolment server in which the device and enrolment server check each other's attestations and determine whether the other party can be trusted, before entering into the secure communication session. Many devices may already have software supporting TLS or DTLS for engaging with operational servers, for example the device may execute a TLS or DTLS software stack which control establishment of the secure session. Hence, by using TLS or DTLS to secure the communications used to establish the operational credentials, this avoids the need for a specific over the air (OTA) mechanism, which may be less preferred as OTA mechanisms are typically specific to a particular mobile network operator.

The command to obtain, from the HSE or the TEE, a bootstrap public key certificate provided as the bootstrap credentials or an operational public key certificate provided as the operational credentials, could be embedded in various parts of the software executing on the device. However, in one particular example it can be useful for the TLS or DTLS software stack to include the at least one command which triggers the HSE or TEE to provide the bootstrap/operational public key certificate. These commands may be defined according to IoT SAFE. The TLS or DTLS software stack could execute at different portions of the device, such as within a cellular module of the deice which includes a modem, or within a microcontroller unit of the device separate from a cellular module.

The HSE or TEE may have a trust anchor store for storing key material and certificates for providing root of trust. A root certification authority (CA) certificate may be retained within the trust anchor store of the HSE or TEE. When the device receives a remote entity's public key certificate signed by a private key of the CA, the device can use the root CA certificate to verify whether the signature is correct and hence whether the remote entity (such as the enrolment server or an operational server) can be trusted.

In some examples, a trusted execution environment (TEE) of the device may be used to provide the bootstrap credentials, and to generate and retain the operational key pair used for the operational credentials. A TEE is an environment provided for executing code on a processor which also supports a normal execution environment, where the processor has an architecture which provides mechanisms for ensuring that the code and data associated with the TEE are protected against access from code executing in the normal execution environment. An example of a TEE may be the TrustZone® architecture provided by Arm® Limited. However, other TEE architectures could also be used. Hence, as the key material may be protected using the TEE, this can provide security by preventing inappropriate access to the keys from the normal execution environment.

However, in other examples the bootstrap credentials may be retained within a hardware secure element and the hardware secure element can be used to generate the operational key pair associated with the operational credentials. Use of a hardware secure elements can provide even greater security because the hardware secure element (also known as a tamper-resistant element) is a hardware device component separate from the main processor of the device, which offers cryptographic services and secure key generation and storage as well as having mechanisms to detect and resist physical tampering with the hardware secure element. This added tamper resistance can help reduce risk of leakage of key material due to physical attacks on the device by an attacker having physical possession of the device.

The hardware secure element could be any tamper-resistant hardware element of the device separate from the main processor, but in one particular example could be a SIM (subscriber identity module). This leverages the fact that often IoT devices may already have a SIM for cellular network communication and so by reusing the SIM to also provide the secure key generation and storage for establishing the operational credentials this does not necessarily increase the hardware cost but can greatly improve security. The use of the SIM may be according to IoT stage as described above.

The credential bootstrapping technique can be used with a range of types of SIM, such as:
a universal integrated circuit card (UICC), which is a traditional SIM provided on a dedicated integrated circuit card separate from the circuit board provided for the device processor, which is able to be removed from the device and replaced if necessary;
an embedded universal integrated circuit card (EUICC, or eSIM), which is a non-removable soldered permanently to a circuit board comprising the device processor, or
an integrated embedded universal integrated circuit card (integrated EUICC or iSIM) which is where the SIM is built as part of the same integrated circuit as the processor (e.g. no longer relying on a separate processor, but instead integrating the SIM functionality into the main device processor and/or cellular modem while still providing the tamper resistance associated with a hardware secure element).

The credential bootstrapping technique may be performed at the point when a device first needs to enrol with a given cloud service, to provide brand new operational credentials which the device can subsequently use for communication with the cloud server.

However, this technique can also be used to renew operational credentials, even if the device already had previous operational credentials used to engage with the operational cloud server. Hence, in some cases the operational credentials established using the method described above may be renewed operational credentials which replace previous operational credentials previously used by the device. Periodically renewing the operational credentials can be helpful to improve security.

Once the operational credentials have been established, the device can then establish a secure session with a cloud server using the operational credentials. For example the secure session may be via an IP communication channel, and may be secured by TLS or DTLS as mentioned above. Hence, the operational credentials established using the credential bootstrapping technique could be used for the handshake performed in TLS or DTLS when determining whether to enter into communication with another party. The other party can use the operational public key and certificate to verify the device's identity to confirm whether the device has possession of the operational private key.

As well as establishing the operational credentials, during the enrolment process, the device could also receive, from the enrolment server, configuration information for use in subsequent communication with a cloud server. For example, the configuration information could comprise an end point address of the cloud server. The configuration information could also include other information such as account details or a user identifier associated with a device which can subsequently be used when accessing the cloud server. Hence, although the protocol for communicating with the enrolment server may be according to EST, cloud-service-specific information could also be returned to the device during the enrolment process, such as account details or a user identifier associated with the device which can then subsequently be used when acceding the cloud server.

### Specific Examples

This application describes techniques for a device (e.g. an Internet of Things (IoT) device) to obtain operational credentials that can subsequently be used, for example, for accessing a server associated with a cloud service.

This application describes merging of Enrollment over Secure Transport (EST-IETF RFC 7030) with GSMA IoT SIM Applet For Secure End-2-End Communication (IoT SAFE). Two standards, IETF RFC 7030 and IoT SAFE, are combined to provide on-board key generation services such that the private key used to establish the TLS handshake is generated within the SIM application (based upon a proprietary trigger in the TLS stack which then triggers the relevant application protocol data unit (APDU) command), and is never disclosed outside of the secure element (Subscriber Identity Module (SIM) or similar technology). The TLS stack is modified to add this possibility to trigger the command in the SIM. IoT SAFE is used over a secure transport, established typically via TLS or DTLS, rather than downloading operational keys using the SIM Over-the-Air (OTA) provisioning technique, as is implied and intended by the IoT SAFE specifications.

Advantages Over the IoT SAFE Standard:

A set of bootstrap credentials are issued and loaded into the application according to secure data generation processes designed for SIMs (UICC), eSIMs (eUICC), and iSIMs (integrated eUICC). These forms of secure element differ in their packaging and represent the evolution of SIM card technology. The present technique is applicable to all secure element technologies. These bootstrap credentials are then used to secure communications used to provision operational credentials to the secure element. This removes the need for an OTA platform, which requires coordination (i.e. typically business contracts and technical coordination) between each cloud provider and each Mobile Network Operator offering an IoT SAFE solution.

The present technique makes IoT SAFE accessible to non-cellular devices since the use of this provisioning solution for operational credentials is connectivity agnostic provided that the device contains a secure element, which is used to bolster the security of the solution. The solution can also be extended to a Trusted Execution Environment (TEE), e.g. by providing an IoT SAFE applet executing in the TEE which functions in the same way as the IoT SAFE applet that would execute within the secure element as defined in IoT SAFE. However, the tamper resistance offered by a hardware secure element may lead increased protection against physical attacks.

The present technique removes the need for relying on SIM OTA provisioning by using the Internet Protocol (IP) based communication channel available to the device. IP-based communication is used to put operational credentials for use with TLS, as required by the using the EST protocol, in place.

Advantages Over the Enrollment Over Secure Transport (EST) Standard:

It bolsters the security inside the device by leveraging the tamper-resistant secure element (hardware secure element), which provides on-board key generation, such that a key pair is generated within the secure element directly and the private key never leaves the secure element. The public key is sent by the modified device middleware in a Certificate Signing Request (CSR) according to the Enrollment over Secure Transport specification. The successful response to a CSR will provide the device with a certificate. This operational credential, i.e. the certificate and the private key, can then be used to securely communicate with cloud-based services, such as a device management platform or some other application services used by the device.

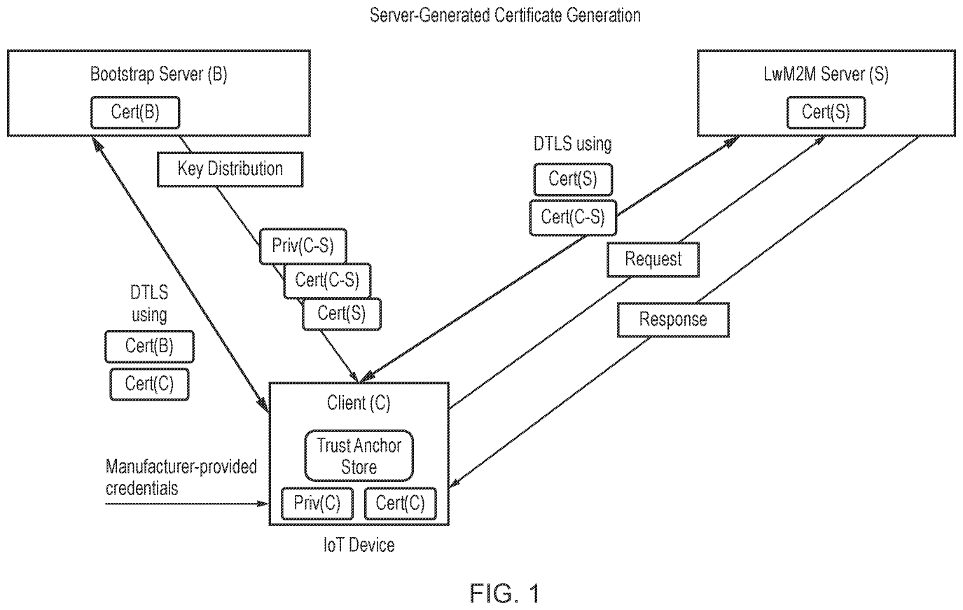

FIG. 1 illustrates server-generated credentials. This approach is used for provisioning symmetric keys, raw public keys, and certificates to IoT devices. Using this approach for asymmetric key cryptography (such as certificates) is done with the argument that many IoT devices are not equipped with a strong random number generator. With server-generated credentials the bootstrap server generates the keying material and sends it to the client (i.e. IoT device). To protect the transfer of these credentials against eavesdroppers along the communication path TLS (or DTLS) is typically used.

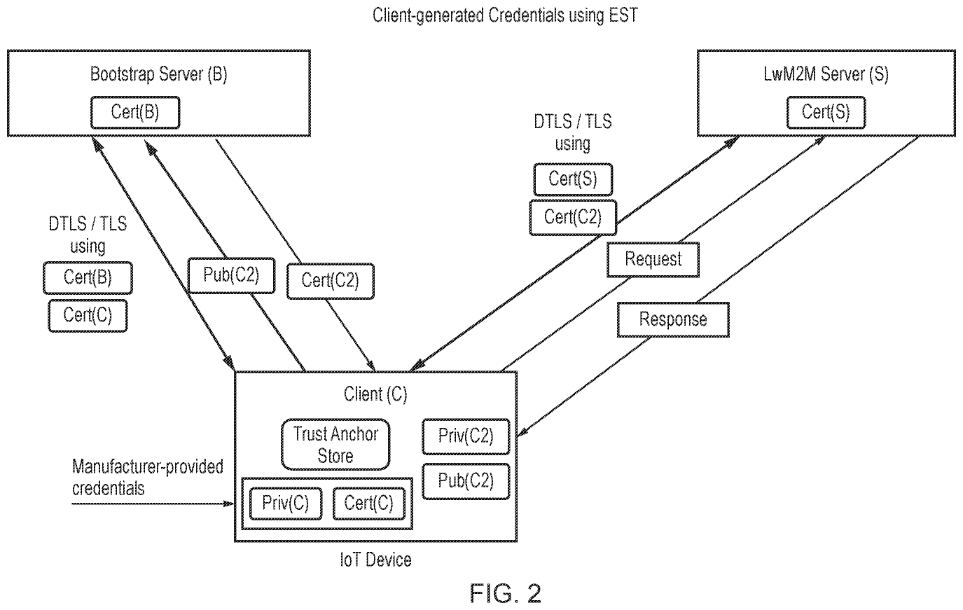

FIG. 2 illustrates client-generated credentials, available with “Enrollment over Secure Transport (EST)” specified in RFC 7030 (for HTTPS) and draft-ietf-ace-coap-est (for CoAPs). The private key remains on the IoT device and the Certificate Signing Request (CSR) is protected using DTLS/TLS. The use of TLS ensures protection against communication security threats since the CSR is sent without further application layer protection. TLS additionally offers mutual authentication so that the server-side can verify the identity of the client/IoT device, which is necessary for producing a certificate. The EST specification focuses on the interoperability of the communication between the client and the server but does not mandate techniques for securing the private key on the device.

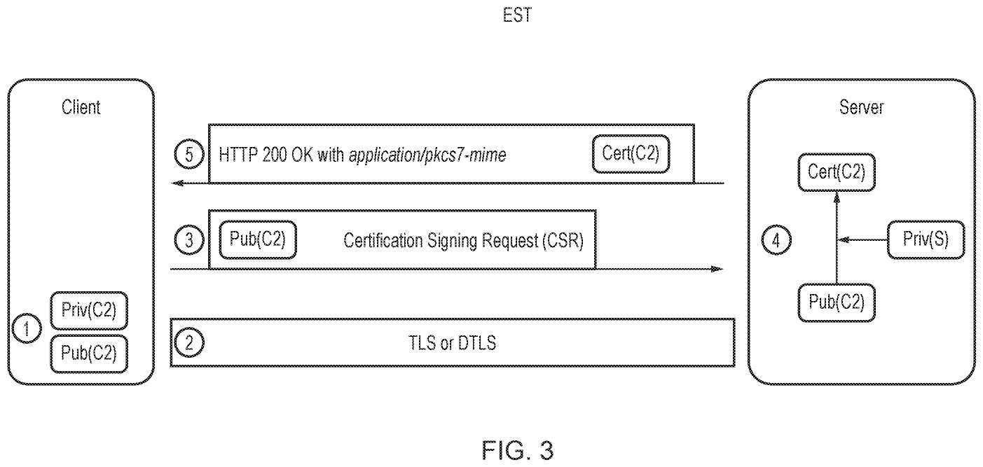

FIG. 3 illustrates Enrollment over Secure Transport (EST) according to RFC 7030. The client device has a private-public key pair (1) for which a corresponding public key certificate is to be established in the enrolment. The client enters into a TLS or DTLS secured communication session (2) with the server. Using the TLS/DTLS secured communication channel, the client sends a CSR (3) to the server to request signing of a public key certificate associated with the public key of the key pair (1). At (4), the server signs the certificate using a private key (Priv(S)) associated with a certifying authority and returns the signed certificate (5) to the client.

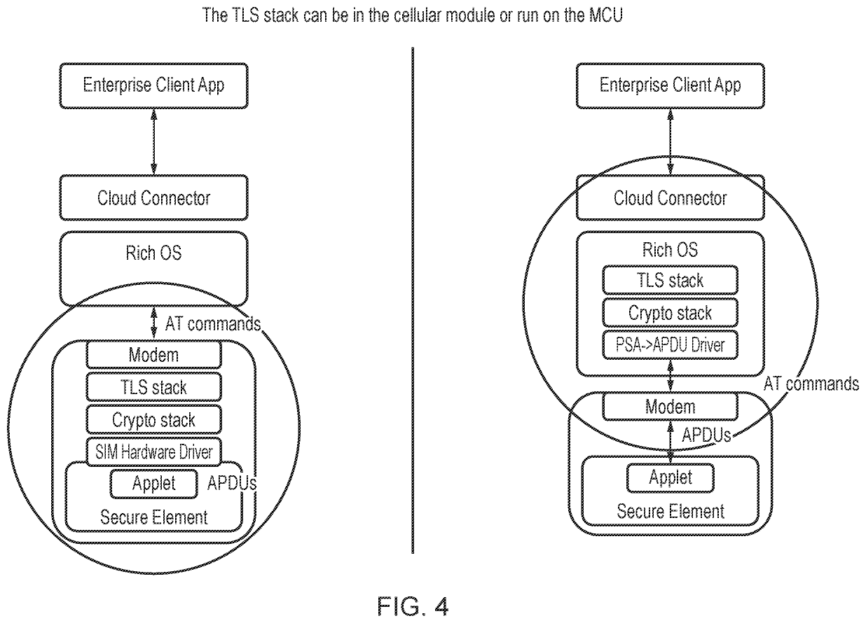

FIG. 4 illustrates software executed on an IoT (Internet of Things) device. The TLS stack for managing the TLS/DTLS handshake can be run within a cellular module or run on a microcontroller unit (MCU).

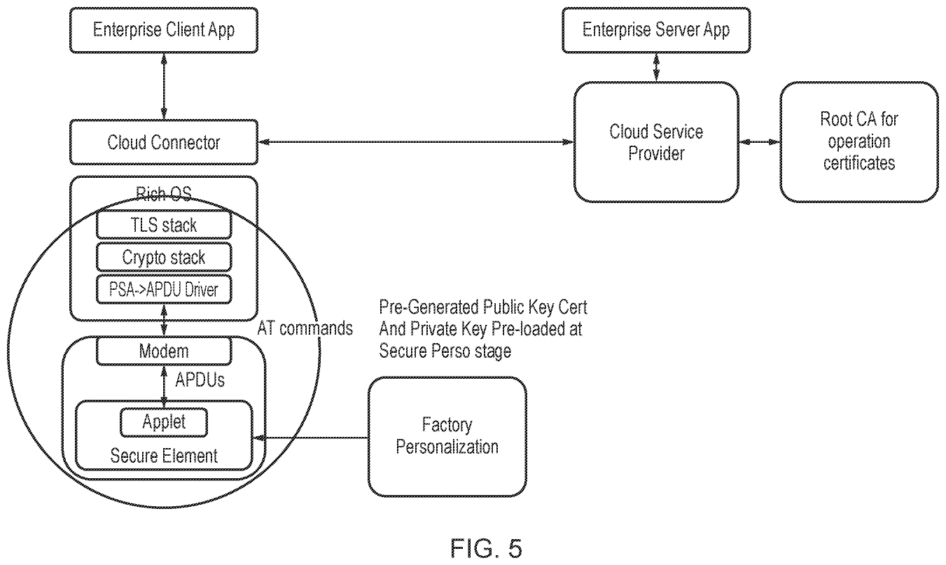

FIG. 5 illustrates an example of use of IoT SAFE in an example where the TLS stack is run on the MCU. An IoT SAFE applet runs within the hardware secure element of the IoT device, to provide digital signature, key storage and on-board key generation services.

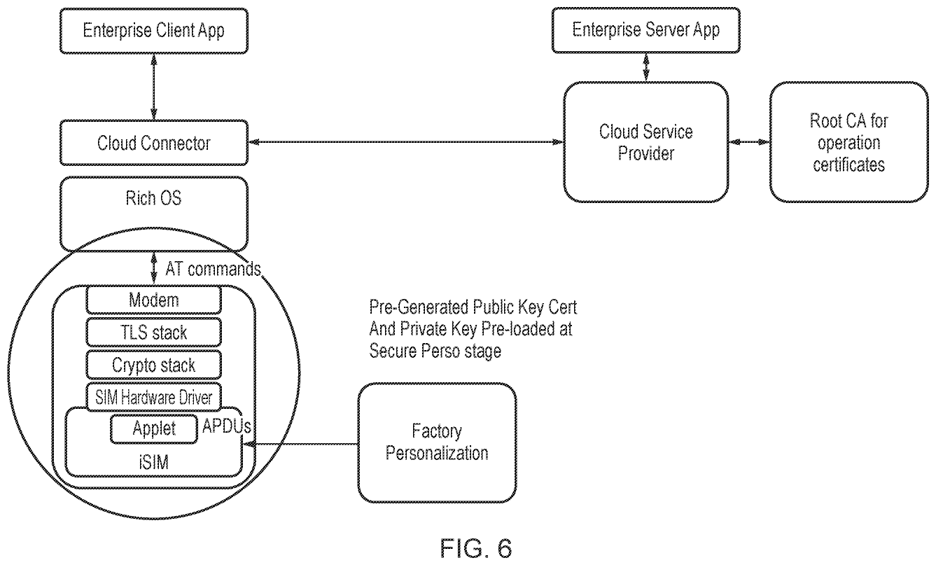

FIG. 6 illustrates another example of use of IoT SAFE in an example where the TLS stack is implemented in the modem within the cellular module.

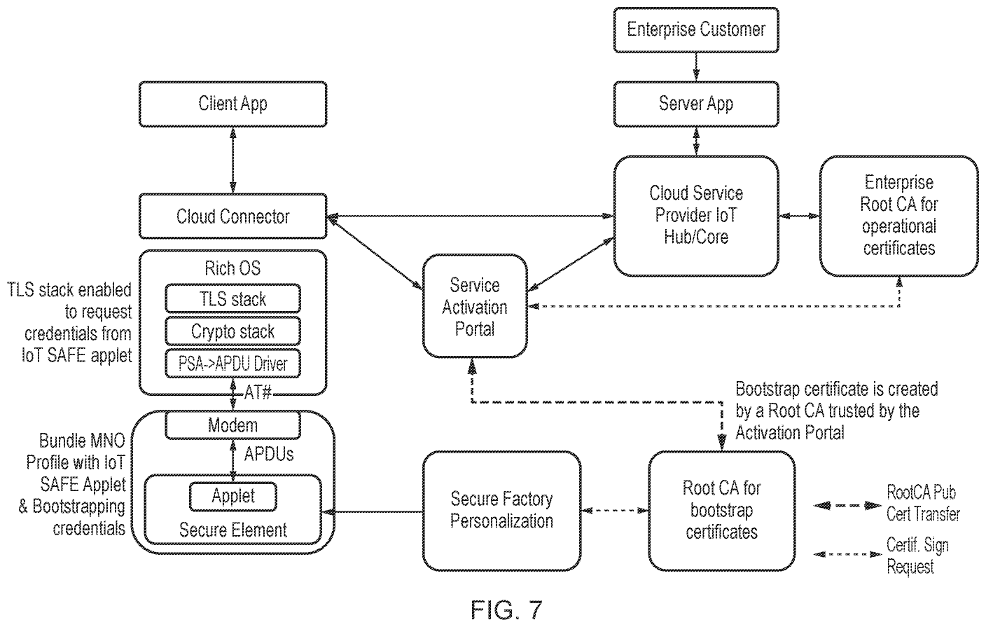

FIG. 7 illustrates merging of IoT SAFE with EST for credential bootstrapping. FIG. 7 is described as an enhancement of FIG. 5 where the TLS stack is run on the MCU. The TLS stack may, however, also be inside the cellular module.

Secure Factory Personalization:

At a manufacturing stage, the bootstrap credentials comprising of a bootstrap private key, a bootstrap public key, and a corresponding bootstrap public key certificate are pre-installed in the hardware secure element of the IoT device. The bootstrap public key certificate is signed (directly, or indirectly) by the private key of a Root Certification Authority (CA), which is trusted by the Service Activation Portal. The Service Activation Portal plays the role of the Enrolment Server, which will later manage enrolment of the IoT device onto a given cloud service.

Enrolment of the IoT Device with a Given Cloud Service:

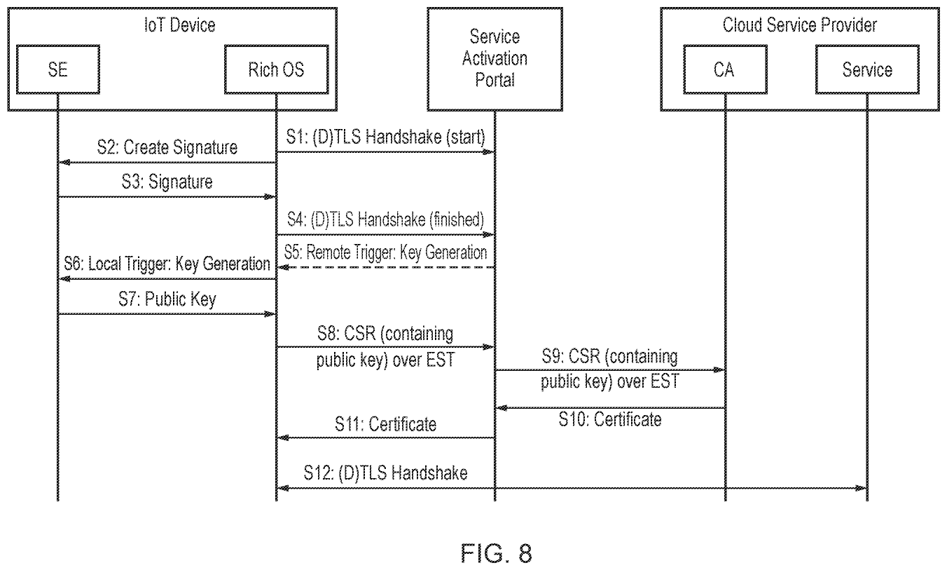

FIG. 8 is a ladder diagram showing communications exchanged during Enrolment. The communications are exchanged between the secure element (SE) of the IoT device, which could be a SIM, iSIM or eSIM as mentioned earlier, the rich OS of the IoT device, the Service Activation Portal (enrolment server) and a Certification Authority (CA) server and service-providing server associated with the given cloud service provider for which the IoT device is being enrolled. In this example, the rich OS serves as the device middleware for establishing the TLS/DTLS secured session and enrolment with the Service Activation Portal, but as shown in FIG. 6, in other examples this device middleware could also be inside the cellular module.

1. The IoT device when put into use and powered on establishes a connection with the Service Activation Portal (at S1 of FIG. 8, the TLS stack on the IoT device initiates the TLS/DTLS handshake). To secure the communication with the Service Activation Portal the bootstrap credentials (obtained from the hardware secure element) are used by the IoT device as part of the TLS/DTLS handshake. During the TLS/DTLS handshake with the Service Activation Portal, the bootstrap public key certificate, signed with the private key of a Root CA, is sent to the Service Activation Portal. During this authentication step the Service Activation Portal has to decide whether to complete the TLS/DTLS handshake with the IoT device and to establish a secure communication session. Note that the TLS handshake also includes the IoT device verifying the Service Activation Portal's credentials as part of the mutual authentication step. This ensures that both parties talk to each other and no man-in-the-middle attacker is present. The bootstrap private key is kept within the secure element and does not leave the secure element. The private key is used by the secure element to compute a digital signature (S2 and S3 of FIG. 8). This digital signature is used by the TLS/DTLS handshake and demonstrates the possession of the private key corresponding to the public key certificate presented by the IoT device to the Service Activation Portal.

2. Once the secure communication channel has been established between the IoT device and the Service Activation Portal (the TLS/DTLS handshake has been successfully completed at step S4 of FIG. 8), the CSR can be sent. The Service Activation Portal issues a remote trigger signal (S5 of FIG. 8) to the IoT device to trigger key generation. In response to the remote trigger, at S6 of FIG. 8, device middleware on the IoT device (e.g. the TLS stack controlling the TLS handshake) issues a command (local trigger) to the IoT SAFE applet on the secure element to request key generation of an operational key pair comprising an operational private key and an operational public key. The operational key pair is the key pair used to establish communications with the cloud server once the device has been enrolled. At this point the IoT device does not yet have an operational public key certificate, signed by a CA that the cloud service provider trusts. This operational public key certificate provides the cloud server demonstration of the device's identity.

3. In response to the command from the device middleware, the IoT SAFE applet generates the operational key pair, and at S7 of FIG. 8 provides the operational public key to the device middleware (e.g. TLS stack). The operational private key remains exclusively within the secure element and does not leave the secure element.

4. At S8 of FIG. 8, the device middleware creates the Certificate Signing Request (CSR) including the operational public key, and transmits the CSR to the Service Activation Portal via the TLS-secured session, according to the Enrollment over Secure Transport (EST) specification.

5. The Service Activation Portal identifies which tenant account, on which specific Cloud Service Provider, the IoT device should be enrolled with, and at S9 of FIG. 8 forwards the CSR to the selected Certification Authority (CA) pertaining to the selected tenant account on a given Cloud Service Provider.

6. The Cloud Service Provider verifies the CSR and, if verified, signs (or delegates to a Certification Authority to sign) the operational public key certificate using a private key associated with the Certification Authority. The signed operational public key certificate is returned at S10 and S11 of FIG. 8, via the Service Activation Portal, to the IoT device, where it can be stored on the device, e.g. as part of the device's Crypto stack. In addition to the operational public key certificate information, configuration information, such as the endpoint address of the cloud server the IoT device should use, are returned to the IoT device.

7. Once the IoT device obtains the operational public key certificate and the configuration information (at least endpoint address) it can start communicating with enrolled cloud service provider (by using the certificate obtained at S11 for a TLS/DTLS handshake at S12 with the cloud server). The cloud service provider will then typically manage the IoT device, for example by configuring actuators, reading sensor values, changing configuration settings and performing firmware updates when bugs in IoT device code are found. When necessary, the cloud service provider can re-invoke the enrolment procedure with the Service Activation Portal to provision new operational credentials.

This approach allows the device to obtain operational credentials, which were not pre-installed during manufacturing, securely thanks to the use of the hardware secure element within the device to protect both the private key associated with both the bootstrap credentials (used to enter into the (D)TLS-secured session with the Service Activation Portal for establishing the operational credentials according to EST) and the private key associated with the operational credentials themselves (used for subsequent communication with the enterprise IoT hub/core instance managed by the cloud service provider).

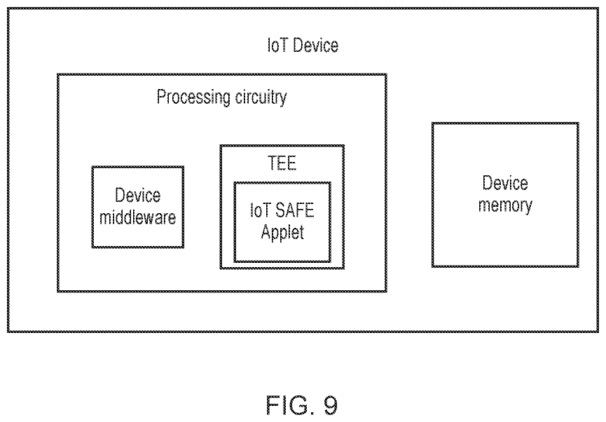

FIG. 9 illustrates another example of the IoT device, in which a Trusted Execution Environment (TEE) implemented on the processing circuitry of the device runs an IoT SAFE Applet which provides equivalent functions to those provided by the IoT SAFE applet shown in FIG. 7 as running on the hardware secure element. The TEE provides architectural mechanisms for ensuring that software executing outside the TEE (such as the Rich OS and device middleware including the TLS/DTLS stack mentioned earlier) cannot access program code or data or associated with the software inside the TEE from the device memory. When the bootstrapping method of FIG. 8 is performed in the example of FIG. 9, the communication flow is the same as shown in FIG. 8, except that the functions of the hardware secure element (SE in FIG. 8) are now performed by software within the TEE instead, and the private keys associated with the bootstrap credentials and operational credentials are retained within a portion of device memory which is accessible to the TEE and is not accessible to software outside the TEE.

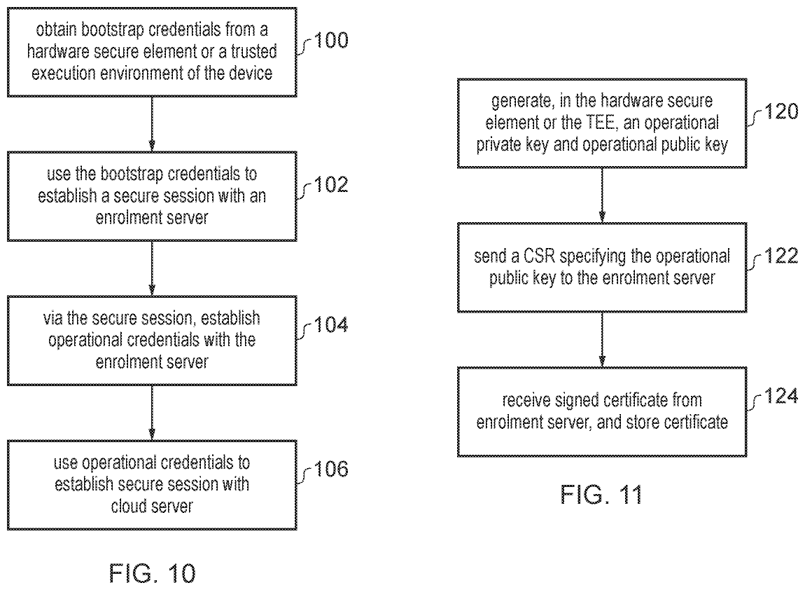

FIG. 10 is a flow diagram illustrating steps performed at an IoT device to establish operational credentials for enabling the device to provide an attestation of the device's identity to another party. At step 100, the device obtains bootstrap credentials from a hardware secure element or a TEE of the device. At step 102, the device uses the bootstrap credentials to establish a secure session with an enrolment server. At step 104, the device and enrolment server communicate via the secure session to establish the operational credentials. At step 106, the operational credentials established at step 104 are used to establish a secure session with a cloud server.

FIG. 11 is a flow diagram showing steps performed at step 104 of FIG. 10 in more detail. At step 120, the device generates, in the hardware secure element or the TEE, an operational private key and operational public key. At step 122 the device sends a certificate signing request (CSR) specifying the operational public key to the enrolment server (with communication still being secured via the secure session established at step 102 of FIG. 10). At step 124, the device receives the signed certificate from the enrolment server, and stores it for later use when accessing the cloud server at step 106.

The term “at least one of: A and B” means that one or both of A and B may be provided. Hence, when the device is defined as comprising at least one of a hardware secure element and a TEE, this means that the device can have a hardware secure element but not a TEE, or can have a TEE but not a hardware secure element, or can have both a hardware secure element and a TEE.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A method for a device to establish operational credentials for enabling the device to provide an attestation of the device's identity to another party; the method comprising:
obtaining bootstrap credentials from a hardware secure element or a trusted execution environment (TEE) of the device;
using the bootstrap credentials to establish a secure session with an enrolment server; and
via the secure session, establishing the operational credentials with the enrolment server.

2. The method of claim 1, comprising generating, in the hardware secure element or the TEE, an operational key pair comprising an operational private key and an operational public key; in which:
the operational credentials comprise an operational public key certificate associated with the operational public key.

3. The method of claim 2, in which establishing the operational credentials comprises:
sending a certificate signing request (CSR) specifying the operational public key to the enrolment server; and
receiving the operational public key certificate from the enrolment server.

4. The method of claim 2, in which the operational private key remains exclusively within the hardware secure element or the TEE of the device.

5. The method of claim 2, in which the operational key pair is generated within the hardware secure element or the TEE, in response to a request by software of the device executed outside the hardware secure element or the TEE, according to IoT SAFE (IoT SIM Applet for Secure End-2-End Communication).

6. The method of claim 1, in which establishment of the operational credentials is performed according to Enrollment Over Secure Transport (EST).

7. The method of claim 1, in which the bootstrap credentials comprise a bootstrap public key certificate and a bootstrap private key, where the bootstrap public key certificate is sent to the enrolment server to establish the secure session, and the bootstrap private key remains exclusively within the hardware secure element or the TEE of the device.

8. The method of claim 7, in which the bootstrap public key and bootstrap public key certificate are obtained from the hardware secure element; and
the bootstrap key pair and the bootstrap public key certificate are pre-installed in the hardware secure element of the device at a manufacturing stage.

9. The method of claim 7, in which software of the device executed outside the hardware secure element or the TEE requests the bootstrap public key certificate from the hardware secure element or the TEE according to IoT SAFE.

10. The method of claim 1, in which the secure session is via an Internet Protocol (IP) communication channel.

11. The method of claim 1, in which the secure session is secured by Transport Layer Security (TLS) or Datagram Transport Layer Security (DTLS).

12. The method of claim 11, in which the device executes a TLS or DTLS software stack to control establishment of the secure session; in which:
the TLS or DTLS software stack includes at least one command to obtain, from the hardware secure element or the TEE, a bootstrap public key certificate provided as the bootstrap credentials or an operational public key certificate provided as the operational credentials.

13. The method of claim 12, in which the at least one command is according to IoT SAFE.

14. The method of claim 1, in which a remote entity's public key certificate is signed by a private key of a certification authority (CA) and a root CA certificate is retained within a trust anchor store of the hardware secure element or the TEE.

15. The method of claim 1, in which the bootstrap credentials are obtained from the hardware secure element, and the hardware secure element comprises a SIM (Subscriber Identity Module).

16. The method of claim 15, in which the SIM comprises one of:
a Universal Integrated Circuit Card (UICC);
an embedded Universal Integrated Circuit Card (eUICC); and
an integrated embedded Universal Integrated Circuit Card (integrated eUICC).

17. The method of claim 1, in which the operational credentials comprise renewed operational credentials to replace previous operational credentials previously used by the device to provide an attestation of the device's identity to another party.

18. The method of claim 1, comprising:
the device establishing a secure session with a cloud server using the operational credentials.

19. The method of claim 1, in which the device receives, from the enrolment server, configuration information for use in subsequent communication with a cloud server.

20. The method of claim 19, in which the configuration information comprises an endpoint address of the cloud server.

21. A non-transitory storage medium storing a computer program to control a device to perform the method of claim 1.

22. A device comprising:
processing circuitry; and
at least one of:
a hardware secure element; and
a trusted execution environment (TEE) implemented on the processing circuitry;
in which:
the processing circuitry is configured to:
obtain bootstrap credentials from the hardware secure element or the TEE;
use the bootstrap credentials to establish a secure session with an enrolment server; and
via the secure session, establish operational credentials with the enrolment server, the operational credentials for enabling the device to provide an attestation of the device's identity to another party.
